(19) United States
(12) Patent Application Publication
(10) Pub. No.: US 2011/0003497 A1
(43) Pub. Date: Jan. 6, 2011

(54) FLUORESCENT LAMP HOLDER ASSEMBLY

(76) Inventor: Viroj K. Pornpan, Bangkok (TH)

Correspondence Address: STEVEN L. NICHOLS;Van Cott, Bagley, Cornwall & McCarthy, 36 South State Street, SUITE 1900, SALT LAKE CITY, UT, 84111, US

(21) Appl. No.: 12/496,395

(22) Filed: Jul. 1, 2009

(51) Int. Cl. H01R 33/02

(52) U.S. Cl. 439/226

(57) ABSTRACT

The invention discloses a fluorescent lamp holder assembly comprising a lamp holder and a socket for receiving said lamp holder. The lamp holder has a body which houses a pair of electrical pin terminals. The body includes a pair of openings on one wall. The opening located at a position corresponds to the position of the electrical pin terminal such that each opening leads to one respective pin terminal. The lamp holder includes a pair of parallel spaced-apart electrical prongs of which one end of each electrical prong is in electrical communication with a pin terminal and the free end of each electrical prong protrudes from said body. The socket has a pair of spaced-apart electrical terminals, each having an opening capable of receiving one electrical prong of the lamp holder. The socket includes a pair of insertion holes for wire connection and includes a horizontal recess on the external walls for coupling to the luminaire. The lamp holder is coupled to the socket by means of inserting a corresponding electrical prong of the lamp holder to the corresponding terminal of the socket.

### BACKGROUND

Fluorescent bulbs are widely known and used in our daily lives including in households and industrial plants. In general, fluorescent bulbs are available in various sizes and lengths, and usually in a bi-pin tubular form. The bulb has two ends and at each end, there is a pair of pins used to connect the bulb to an electrical source. Each pair of the pins on each end of the bulbs are aligned in the same direction and at the identical position wherein, during installation, the pins are inserted into the slit and in between two electrical pin terminals of the lamp holder, allowing electrical current to pass through to the lamp.

One known lamp holder called “twisted type,” as shown in FIG. 1, comprises a base and a body integrally formed thereto. Inside the body there is a pair of electrical pin terminals, usually made of copper plate or other electrically-conductive metals. The body includes a slit wherein the copper terminal extending from the base is naked and visible through the slit. During installation, the pins on one end of the bulb are inserted first, and then the other end follows the same way. The bulb is then twisted or rotated allowing the pins to come in contact with the copper plate pin terminal and allowing the current to pass through and light the lamp, while at the same time securing the bulb to the lamp holder.

One disadvantage of this type of lamp holder is that during installation of the bulb into the lamp holder, it is necessary to insert the pins of the bulb into the slit of the lamp holder precisely so that the pins on both ends of the bulbs are properly inserted into the slit at the same time. This proves to be rather difficult for some persons, especially when the pin and the slit are very small, and in particular when such installation is performed on a step ladder. Breaking of the pins or falling from a step ladder is not uncommon for non-skilled persons.

Another known type of a lamp holder is called a “spring type” as shown in FIG. 2 wherein such lamp holder includes a pair of spaced-apart electrical pin terminals connected to a wire through a pair of openings on the lower base of the body. A pair of through holes is prepared on the central region on one wall of the lamp holder wherein the pin of the bulbs may be inserted through so as to engage with the pin terminals. This thereby allows the current to pass through to the bulbs. The main characteristic of this type of lamp holder is that the central region of the wall where the through holes are located are separate from the larger wall and situated on a spring, thereby enabling the area to move when the spring is exerted. During installation of a bulb, the pins on one end of the bulb are inserted first, while pressing the spring inward, and the other end follows the same way. The exertion of the springs on each end of the bulb holds the bulb in place.

As with the “twisted type” lamp holder, the disadvantage is that the installation of the pins of the bulb to the small opening on the lamp holder has to be done precisely, and prove to be difficult for some persons. Breaking the bulb or pins is not uncommon especially when the person does not know the strength of the spring and unintentionally presses the bulb against the spring too hard.

Therefore, it is an objective of the present invention to provide an alternative fluorescent lamp holder wherein installation of a bulb to a lamp holder can be done conveniently and with ease.

### BRIEF DESCRIPTION OF THE DRAWINGS

The accompanying drawings illustrate various embodiments of the present invention and are a part of the specification. The illustrated embodiments are merely examples of the present invention and do not limit the scope of the claims.

FIG. 1 shows an embodiment of the conventional “twisted type” lamp holder;

FIG. 2 shows an embodiment of the conventional “spring type” lamp holder;

FIG. 3 shows an embodiment of the fluorescent lamp holder assembly according to the present invention wherein the assembly is already assembled to a bulb and a luminaire;

FIG. 4 shows a blown apart view of an embodiment of the fluorescent lamp holder assembly according to the present invention;

FIG. 5 shows a blown apart view of further embodiment of the fluorescent lamp holder assembly according to the present invention; and

FIG. 6 shows an embodiment of a fluorescent lamp holder assembly according to the invention wherein the lamp holder includes more than one docks with a pair of openings on each dock.

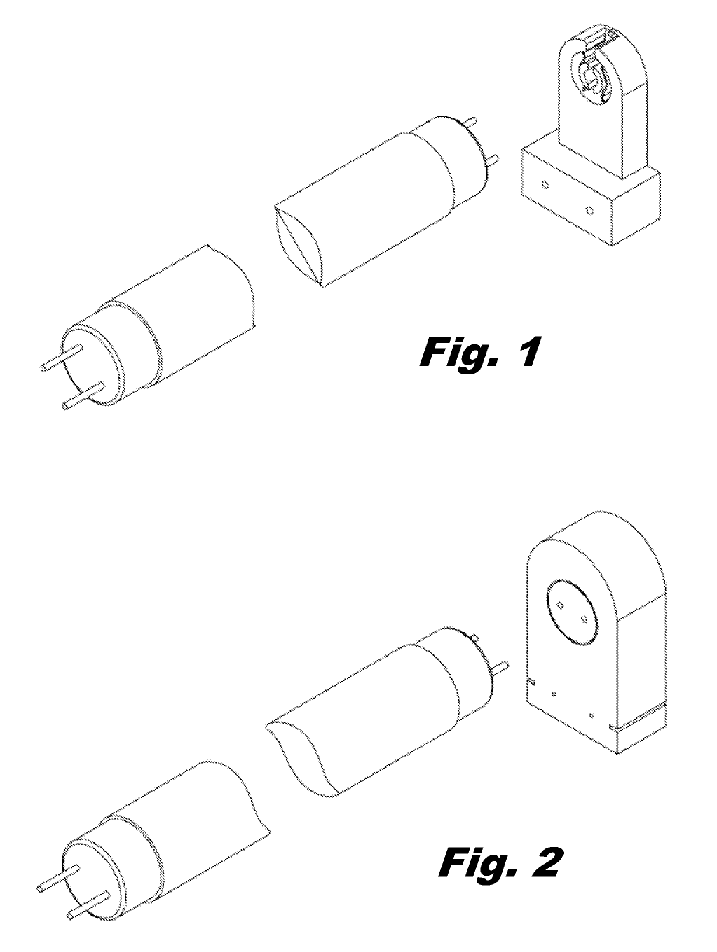

### DETAILED DESCRIPTION

The present specification describes a fluorescent lamp holder assembly for installation of a bi-pin bulb, enabling the bulb to be installed with ease and little skill. The lamp holder may be installed with the existing bulb and luminaries.

In various embodiments, the fluorescent lamp holder assembly includes a lamp holder and a socket assembled together. The lamp holder includes a body which houses a pair of electrical pin terminals similar to the conventional plug. Each pin terminal is made of a pair of copper plates flexibly facing one another, having a distance for insertion of the pin of the bulb there between. The distance between the pair of pin terminals corresponds to the distance of the pins at the end of the bulb. At one end of the lamp holder there is a pair of electrical prongs. Each electrical prong is connected to the corresponding pin terminal.

The socket has a rectangular shape having its size corresponding to the size of the luminaire such that the socket can be assembled into the luminaire. The socket is provided with a pair of insertion inlets similar to the conventional wall socket. The insertion inlet is spaced apart with a distance corresponding to the distance of the electrical prongs of the lamp holder. The socket also includes two insertion holes for an electrical wire connection.

The socket is assembled to the luminaire, one on each end. The lamp holder is assembled to the bulb, one on each end of the bulb. The bulb with lamp holders assembled thereto is subsequently assembled to the socket, completing the assembly.

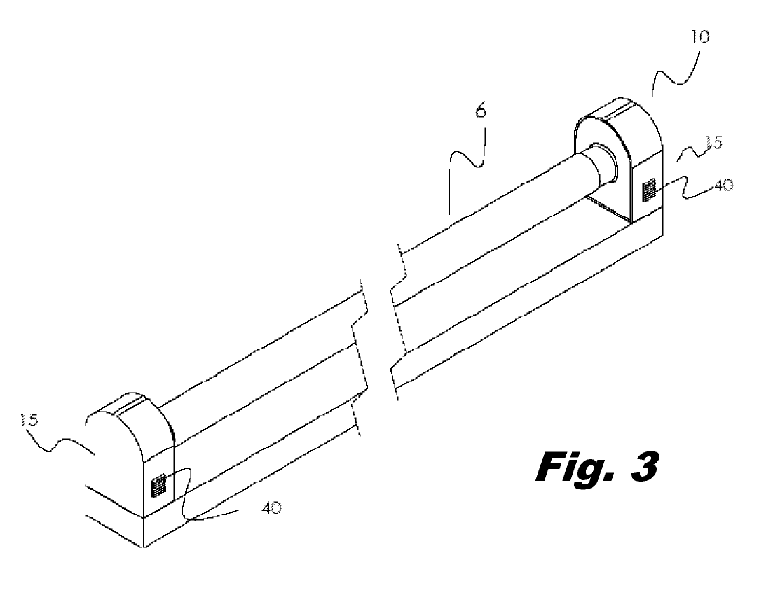

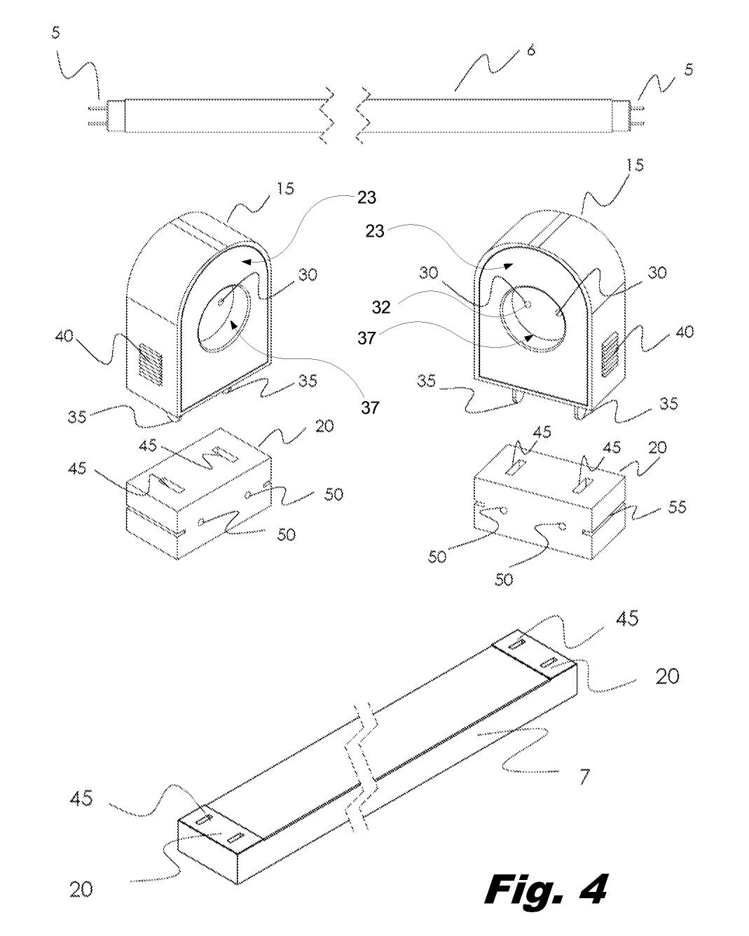

FIG. 3 and FIG. 4 show an embodiment of the fluorescent lamp holder assembly (10) according to the principles described herein. The lamp holder (15) and the socket (20) are produced by plastic injection molding. The lamp holder (15) and the socket (20) are two separate pieces which can be assembled together. The lamp holder (15) includes a body which houses at least one pair of electrical pin terminals (32) similar to a conventional plug. Each pin terminal (32) is made of a pair of copper plates flexibly facing one another, enabling the pins (5) of the bulb (6) to be inserted there between. The two pin terminals (32) are spaced apart and the distance between the pin terminals (32) corresponds to the distance of the pins (5) on the end of the bulb (6). The lamp holder (15) is prepared with at least one pair of openings (30) located on at least one of the walls of the body, however more specifically at the wall (23) which will be in contact with the pins (5) of the bulb (6). The openings (30) are able to receive pins (5) at the end of the bulb (6) and guide the bulb pins (5) so that the pins (5) are allowed to come in electrical communication with the pin terminals (32). Accordingly, it is essential that the openings (30) are spaced apart and the distance between the two openings (30) correspond or, more specifically, are equal to the distance between the pair of pins (30) at the end of the bulb (6).

In one embodiment of the lamp holder (15) as shown in FIG. 3, the central region of the wall (23), in particular, where both openings (30) are located, is positioned deep inside the body creating a circular shape dock (37) for the bulb's end. At least one dock (37) is integrally formed on the wall (23) through injection molding. Preferably, the dock (37) is prepared with a diameter larger than the diameter of the bulb (6), in particular, a tubular bulb so that the bulb's end can be inserted there through in order that the pins (5) on the bulb's end can able to engage with the opening (30). As mentioned above, the pin terminals (32) are made of a pair of copper plates flexibly facing one another, enabling the pins (5) of the bulb (6) to be inserted there between. Preferably, the engagement of each copper plate should be made with sufficient force such that once the pin (30) of the bulb (6) is inserted between said copper plates, the pin (5) is securely held in position securing the bulb (6) to the lamp holder (15). On one end of the body, in particular the end which will be in contact with the socket (20), a pair of spaced apart electrical prongs (35) protrude from the body. The electrical prongs (35) are prepared in the same manner as a conventional (attachment) male plug and may be a plate type or a pin type or any other shape whose shape and size corresponds to the shape and size of the insertion holes (45) on the socket (20). One end of each electrical prong (35) is in electrical communication with the copper plates of each pin terminal (32), leaving the free end of the electrical prong (35) to be inserted into the insertion hole (45) of the socket (20). The wall (23) of the body of the lamp holder (15), at least on the external sidewalls, is prepared with a surface texture or patterns (40) that enhances finger grip for better handling of the article while assembling and/or disassembling the assembly.

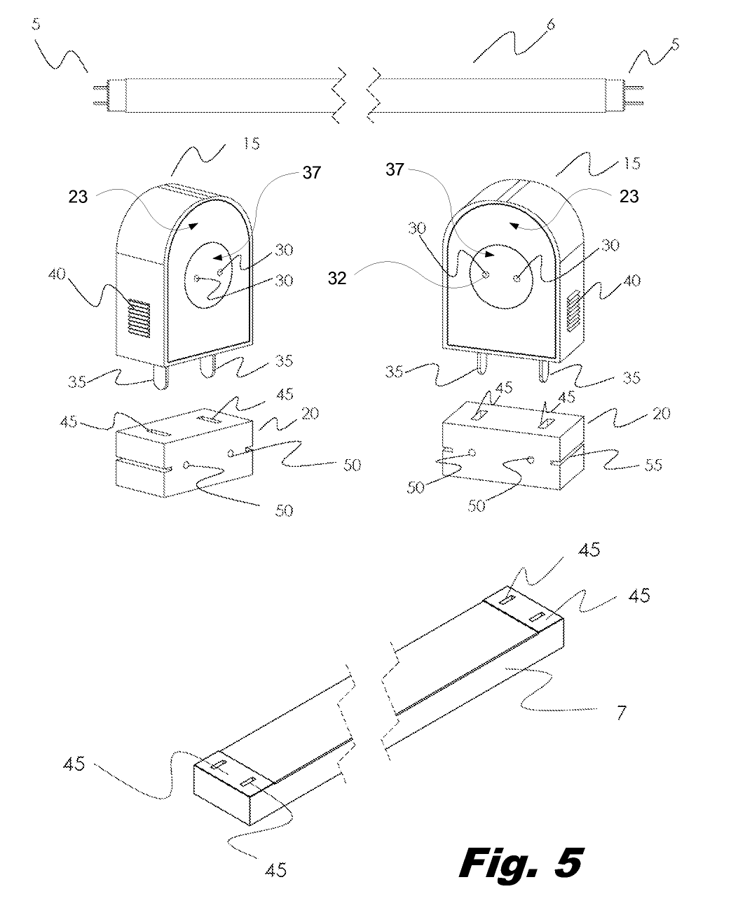

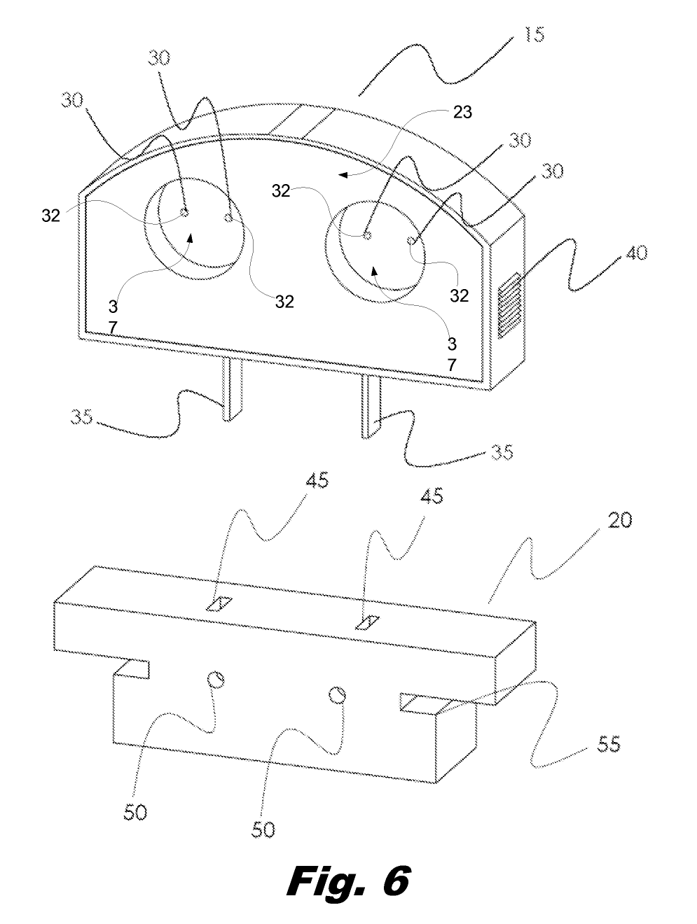

FIG. 5 shows another embodiment of the lamp holder (15). In this embodiment, the lamp holder (15) does not include a dock (37) as with the earlier described embodiment. In this embodiment, the central region of the wall (23), in particular where the openings (30) are located, are level with the rest of other region of the wall (23) surface.

Yet a further embodiment of the lamp holder (15) (not shown) includes more than one pair of openings (30). As shown in FIG. 6, this embodiment of the lamp holder (15) includes a second set of pairs of the openings (30) on the wall (23) opposite to the wall (23) where the first set of pairs of openings (30) are located. The embodiment allows a binary fixture, single file, or multidirectional fixture of the bulb (6) using a shared lamp holder (15).

In yet another embodiment of the lamp holder (15) (not shown), the lamp holder (15) include an electronic ballast within its body.

The socket (20) forms part of the assembly and includes a body configured to correspond to the shape and size of the luminaire (7) such that the socket (20) can be fitted inside the luminaire (7). The socket (20) houses an electrical conductive metal plate and wiring as in the conventional socket. According to one embodiment of the socket (20), as shown in FIG. 4 and FIG. 5, the socket (20) has a rectangular shape and is provided with a pair of insertion inlets (45) similar to the conventional wall socket. The pair of insertion inlets (45) are spaced apart, separating each insertion inlet (45) with a distance corresponding to the distance of the electrical prongs (35) of the lamp holder (15). The shape and size of the opening of the insertion inlet (45) corresponds to the shape and size of the electrical prong (35) of the lamp holder (15), enabling the electrical prong (35) of the lamp holder (15) to be inserted into the insertion inlet (45) while maintaining a tight coupling of the lamp holder (15) to the socket (20). The socket (20) also includes two insertion holes (50) for wire connection with the electrical source. A recess (55) is prepared on the external wall of the socket (20) for coupling the socket (20) to engage with a flange inside the luminaire (7). Accordingly, the position of the recess (55) should correspond with the position of the flange inside the luminaire (7) whereby the flange of the luminaire is able to latch to the recess (55) of the socket (20).

FIG. 3 shows a complete assembly of the fluorescent lamp holder (10). For one bulb lighting fixture, at least a pair of the lamp holder assemblies (10) (including a pair of the sockets (20)) is needed. Preferably, a pair of the sockets (20) is first fitted into the luminaire (7) via a coupling mechanism comprising the recess (55) on the socket (20) and the flange of the luminaire (7), with one on each end of the luminaire (7). A pair of lamp holders (15) is fitted to the bulb (6), in a similar manner, one on each end of the bulb (6) whereby the pins (5) of the bulb (6) are inserted into the opening (30) of the lamp holder (15). The bulb (6) having lamp holders (15) fitted on each end is subsequently fitted to the socket (20) by simply inserting the electrical prong s (35) of the lamp holder (15) into the insertion inlet (45) of the socket (20). As can now be appreciated, the fact that fluorescent lamp holder assembly (10) is prepared with the lamp holder (15) and the socket (20), the fitting of bulb (6) into the lighting fixture can be done with ease.

When there is a need to replace the bulb (6), both the bulb (6) and the lamp holder (15) can be removed from the socket (20) as just easily. The new bulb (6) and the lamp holder (15) may be assembled together on the floor making it easier to insert the pins (5) of the bulb (6) into the opening (30) of the lamp holder (15), thus avoiding bending or breaking of the pins (5). In addition, the fact that the bulb (6) and the lamp holder (15) can be assembled together on the floor eliminates the need to perform the same steps on a step ladder as is required in a conventional method of installation of a bulb to a lamp holder.

The various embodiments described herein help to reduce injuries associated with falling from the step ladder while trying to insert the pins (5) on the end of the bulb (6) into the opening (30) of the lamp holder (15), which is more difficult than performing the same steps on the floor. In particular, this makes the installation of the bulb easier for non-electricians because the pins (5) and the opening (30) on the lamp holder (15) are quite small. The user can pre-assemble the bulb (6), the lamp holder (15), and the socket (20) to the luminaire (7) and simply insert the electrical prongs (35) of the lamp holder into the socket (20). It is just as simple as plugging in general electrical devices.

What is claimed is:

1. A fluorescent lamp holder assembly comprising:
a lamp holder having a body which houses at least one pair of electrical pin terminals, the body includes at least one pair of openings on at least one wall, the opening located at a position corresponding to the position of the electrical pin terminals such that each opening leads to one respective pin terminal; the lamp holder includes at least one pair of parallel spaced-apart electrical prongs of which one end of each electrical prong is in electrical communication with a pin terminal and the free end of each electrical prong protrudes from the body;
a socket having at least one pair of spaced-apart electrical terminals, each defining an insertion inlet capable of receiving one electrical prong of the lamp holder; the socket includes at least one pair of insertion holes for wire connection; the socket includes a horizontal recess on the external walls;
in which the distance between the pair electrical prongs of the lamp holder corresponds to the distance between the pair of terminals on the socket such that the lamp holder is coupled to the socket by means of inserting a corresponding electrical prong of the lamp holder to the corresponding terminal of the socket.

2. A fluorescent lamp holder assembly according to claim 1, in which the wall of the lamp holder body where the openings are located is flat and level with the rest of the wall surface.

3. A fluorescent lamp holder assembly according to claim 1, in which the wall of the lamp holder body includes at least one dock integrally formed on the wall; and in which a pair opening is located inside the dock; said docks capable of receiving an end of a bulb.

4. A fluorescent lamp holder assembly according to claim 3, in which the dock has a tubular shape having its diameter greater than a diameter of a bulb.

5. A fluorescent lamp holder assembly according claim 1, in which the electrical prongs of the lamp holder body is a blade type electrical prong.

6. A fluorescent lamp holder assembly according to claim 1, in which the terminals of the socket are spaced-apart with a distance corresponding to the distance between each electrical prong of the lamp holder; and in which the shape and size of the insertion inlet of the terminal of the socket corresponds to the shape and size of the electrical prongs of the lamp holder such that a secure coupling of the lamp holder to the socket is achieved.

7. A fluorescent lamp holder assembly according to claim 1, in which the lamp holder includes a grip enhancing surface textures or patterns on the external surface of the body.

8. A fluorescent lamp holder assembly according to claim 1, in which the socket further includes electronic ballast.

9. A fluorescent lamp holder assembly according claim 1, in which the electrical prongs of the lamp holder body is a pin type electrical prong.

10. A lamp holder comprising:
a body,
a number of pairs of openings on a number of walls of the body,
a number of pairs of spaced-apart electrical pin terminals attached to the pairs of openings, and
a number of pairs of parallel spaced-apart electrical prongs in electrical communication with the pairs of spaced-apart electrical pin terminals.

11. The lamp holder according to claim 10, in which the wall of the lamp holder body where the openings are located is flat and level with the rest of the wall surface.

12. The lamp holder according to claim 10, in which the wall of the lamp holder body includes at least one dock integrally formed on the wall; and in which a pair opening is located inside the dock; said docks capable of receiving an end of a bulb.

13. The lamp holder according to claim 12, in which the dock has a tubular shape having its diameter greater than a diameter of a bulb.

14. The lamp holder according claim 10, in which the electrical prongs of the lamp holder body is a blade type electrical prong.

15. The lamp holder according claim 10, in which the electrical prongs of the lamp holder body is a pin type electrical prong.

16. The lamp holder according to claim 10, in which the lamp holder includes a grip enhancing surface textures or patterns on the external surface of the body.

17. The lamp holder according to claim 10, in which the socket further includes electronic ballast.

18. A socket comprising:
a number of insertion inlets;
a number of insertion holes in electrical communication with the number of insertion inlets and for wire connection with an electrical source; and
a recess on the external wall of the socket for coupling the socket to a flange inside a luminaire.

19. The socket according to claim 18, in which the number of insertion inlets are spaced apart by a distance corresponding to the distance of a number of electrical prongs.

20. The socket according to claim 18, in which the socket is configured to receive a lamp holder.
